(19) United States
(12) Patent Application Publication
(10) Pub. No.: US 2018/0258292 A1
(43) Pub. Date: Sep. 13, 2018

(54) Porous Silicon Oxide Beads for Use As Drying Agents for Waterborne Latex Paint Compositions

(71) Applicant: Potters Industries, LLC, Wilmington, DE (US)

(72) Inventors: Suruliappa Jeganathan, Chadds Ford, PA (US); Kenneth Berg, North Wales, PA (US); Neil Miller, King of Prussia, PA (US)

(21) Appl. No.: 15/455,617

(22) Filed: Mar. 10, 2017

(51) Int. Cl. C09D 5/33; C09D 139/06; C09D 7/12; E01F 9/524

(52) U.S. Cl. CPC C09D 5/004; E01F 9/524; C09D 7/1216; C09D 139/06

(57) ABSTRACT

A highway marking paint is provided formed from a waterborne latex paint and porous silica beads having a pore volume in the range of 0.3 cc/g to 3.0 cc/g. The silica beads enable the paint to achieve sufficient viscosity to permit the application of a highway marking of at least 40 mil and preferably at least 120 mil. The highway marking paint can also include retroreflective glass beads. Optionally, the highway marking paint further includes an acrylic polymer emulsion. The porous silica in bead form enhances the flowability of the porous silica beads and retroreflective beads.

### BACKGROUND OF THE INVENTION

### Field of the Invention

The present invention relates to the field of drying agents for waterborne paints and more particularly to drying agents in the form of porous silica beads for rapidly drying waterborne latex paint compositions and methods for manufacturing thereof.

### Description of the Related Art

Two desirable features for highway marking paint compositions are that the compositions are durable and that they dry rapidly. Because of the manpower involved in marking roadways and the associated material costs, it is desirable that a highway marking last a minimum of 4 years and more preferably up to 7 years or longer. Moreover, it is highly desirable that the highway marking dry rapidly to prevent the paint from running across the roadway and to minimize the disruption to traffic flow while the highway marking is being applied.

One technique to enhance durability is to apply a thicker layer of paint. A thin paint layer of 25 mil or less will likely have a 1 year life and at best 2-3 years. A thicker paint layer of 60 mil or greater will typically last for 4-7 years. Accordingly, there is a strong desire to apply a thicker paint layer when marking highways. In order to do so, however, there is a need to rapidly dry the paint.

There are some technologies known to reduce the drying time of paints. U.S. Pat. No. 5,340,870 describes a fast drying system by increasing the solid contents of the paint composition and reducing the amount of water in that composition. A filler such as calcium carbonate is added to an acrylic binder to increase the viscosity and dry time of the paint. The filler is added at a 60-75% ratio relative to the binder. Because of the high content of the inorganic filler the paint dries quickly but its storage stability is poor and it does not give durable markings once applied on roads. Moreover, this approach does not address the drying problems when the paint is applied at high humidity.

U.S. Pat. No. 6,013,721 describes the use of polyfunctional amine polymer produced from acrylic monomers mixture containing at least one acid monomer and one amine monomer. This technology helps to adjust the pH of the composition.

U.S. Pat. No. 5,544,972 shows the use of spraying mineral acid into paint stream to accelerate the drying time of binders. This acid spray, when it comes in contact with paint, coagulates the resin salt by an acid-base reaction. This method is not practical in roads as the use of mineral acids poses health and corrosion hazards.

U.S. Pat. No. 5,947,632 describes the use of ion exchange resins as drying agents. Ion exchange resins are hollow polymers which absorb water in the paint and reduce the drying time on traffic markings. Such ion exchange resins include super absorbent polymeric gels (Sumica gel) and solid hollow sphere polymers (Ropaque® OP-62). This patent also mentions inorganic compounds capable of absorbing water by coordination, although experimental examples are provided only for the ion exchange resins.

U.S. Pat. No. 6,132,132 discloses the use of water absorbing particles such as talc, hollow sphere polymers, solid polymers, and inorganic compounds to improve the drying time of waterborne paint. Except for the ion exchange resin, no examples were provided revealing the performance of the drying agents mentioned.

U.S. Pat. Nos. 6,475,556 and 6,413,011 describe water absorbing particles from the group of organic super-absorbent polymers, ion exchange resins, hollow sphere polymers, molecular sieves, talcs, synthetic zeolites, inorganic absorbers, porous carbonaceous materials, and nonporous carbonaceous materials. Except for the ion exchange resins such as Amberlite®, Amberlyst®, among others, no examples were provided for the other water absorbing particles.

U.S. Pat. No. 6,645,552 describes the use of ion exchange resin Amberlite IR 120H as a drying agent and also uses extenders like talc, clays, silicas and silicates.

U.S. Pat. Nos. 6,013,721, 5,947,632, 6,132,132, 6,475,556, 6,645,552 and 6,413,011 all describe the use of large particle silica gel (Silica S21), alumina, silica-aluminas, silicas and silicates as extenders in the paint formulation. Extenders are inactive materials present in any paint formulation to improve color and flow properties of the paint.

U.S. Pat. No. 4,159,296 describes the preparation of kaolin clay pellets from clay particles agglomerated using a pin mixer.

U.S. Pat. No. 7,603,964 describes the process of making composite particles useful as animal litter using a pin mixer.

U.S. Pat. No. 9,228,246 describes a method of agglomerating silicon and silicon carbide particles from wiresawing waste into pellets.

Although the systems discussed in the patents above were able to speed up drying time of the highway paint, they were not able to achieve waterborne traffic markings having a thickness greater than 30 mil wet thickness. At such a thickness, the underlying roadway will need to be repainted on an annual basis. Moreover, the ion exchange resins described above absorb water at the same time the sulfonic acid group slowly reacts with acrylic resins thus weakening the resin. In addition, the brown color of the ion exchange resin makes the white highway marking line dirty and brown spots are seen after the traffic lines are striped.

More recently, the use of porous silica particles has been used as a drying agent to absorb water. Such porous silica particles were found to be four times more efficient than ion exchange resin. In U.S. Pat. No. 9,145,651, porous silica particles are used to apply durable water borne latex paint over 40 mil wet thickness where the porous silica achieves the desired viscosity by its drying effect. In U.S. Pat. No. 9,222,230, porous silica in particle form is used for drying water borne paint used in traffic markings. The porous silica drying agent can be used as an intermix with water borne latex paint. One drawback to the use of porous silica particles is the flowability of the particles when intermixed with retroreflective glass beads.

### SUMMARY OF THE INVENTION

The present invention uses porous silicon dioxide, in bead form, as drying agents for waterborne paint. Waterborne paints are more widely used in traffic markings and in other coating applications than solvent borne paints due to environmental reasons and ease of material handling. However, waterborne paints take a longer time to dry than solvent borne paints, and reduced drying time is economical and efficient when traffic markings are applied on roads, airports, and other surfaces.

U.S. Pat. Nos. 9,145,651 and 9,222,230 describe the use of porous silica, in particle form, for drying water borne paint used in traffic markings. During the manufacturing of porous silica particles, some particles smaller than 100 microns will pass through a filter and become difficult to recover from waste water. To prevent this difficult treatment problem, high value porous silica particles are needed to carry out this process. Moreover, it has been found that the flowability of the porous silica particles when intermixed with retroreflective glass beads is not favorable.

This invention describes a fast drying porous silicon oxide, in bead form, as a drying agent for waterborne paints used in traffic markings on road, airport and other surfaces. In the past, nonporous silica and silicates were used as extenders in paint formulations. Because these nonporous materials are not capable of absorbing water, they could be used as extenders in water based paint formulations. More recently, particles of porous silicon dioxide have been used as drying agents for waterborne paints by absorbing water into the pores of the silicon dioxide.

Porous silicon oxide beads can be added to the paint during or after the traffic markings are striped onto the road. Porous silica beads optionally can be mixed with retro-reflective glass beads and then applied to paint during or after the paint is applied. Generally this drying agent, a mixture of glass beads and porous silica beads, is applied by pumping the dry mixture from a tank with a moderate pressure which flows through a tube and then applied onto the paint. The mixture of glass beads and porous silica in granule form sometimes does not fluidize easily, requiring an increase in pressure. This problem can be solved by using porous silica in spherical or bead form. The mixture of porous silica beads and glass beads has improved flow properties.

Another objective of this invention is to incorporate glass dust (less than 30 microns) into the beads and thus increase the density compared to silica itself. Higher density silica beads further help the flow properties.

Another objective of the present invention is to use low value porous silica particles, coming out of manufacturing, as a silica source and convert the low value material into a usable product. The low value silica particles are less than 60 microns and collected as a press cake after filtering water. This press cake is converted to beads using a pin mixer.

Another objective of the present invention is to utilize low value silica and glass fines in a saleable product. The glass fines are mixed with low value silica press cake in the range of 10 to 50% by weight.

### DETAILED DESCRIPTION OF THE PREFERRED EMBODIMENTS

Porous silicon dioxide beads used in this invention can have a pore volume of 0.3 cc/g to 3.0 cc/g. The preferred material has a pore volume of 0.5 cc/g to 1.5 cc/g. The amount of porous silica which can be added to the paint can be from 5% to 20% wt/wt to the paint. The preferred amount is 10% to 18%. This amount can be adjusted depending on the pore volume of silicon oxide.

The surface area of porous silicon oxide beads can be from 200 m²/g to 500 m²/g, preferably from 250 m²/g to 450 m²/g.

Porous silicon dioxide beads used in this invention can be used as intermix with latex paints by injecting the drying agent into the paint stream, or can be added on the top of paint layer.

Porous silicon oxide beads used in this invention range in size from 10 US Mesh to 150 US Mesh. Preferred particles are 16 US Mesh to 100 US Mesh, and the optional product is from 18 US Mesh to 80 US Mesh.

Porous silicon oxide particles can be blended with retro reflective glass beads of refractive index 1.5 to 2.2, preferably 1.5 to 1.9. Retroreflective glass beads particle size can be from 16 US Mesh to 100 US Mesh.

### EXAMPLES

### Example 1: Porous Silica Beads Using Polyvinylpyrrolidone Binder

Dried silica press cake (1.51 Kg., 16.08% wt/wt water) is weighed into the pan of a Model RV02E Eirich Laboratory Mixer fitted with a pin type rotor tool. The pan is then mounted onto the mixer. The rotor is spun at a tip speed of 15 m/s, and the pan is rotated at 37.5 RPM in a counter-rotational direction. After 0.5 minute of mixing, 0.7978 kg water is rapidly poured into the pan. After a total of 3 minutes of mixing, 0.16 kg PVP solution (containing 0.0264 kg polyvinylpyrrolidone K-30 completely dissolved in water) is gradually sprayed into the pan over 10 to 45 seconds. After a total of 3.75 minutes of mixing, the rotor speed is increased to 30 m/s. After 9.75 minutes total of mixing, the rotor speed is reduced to 20 m/s. After 11 minutes total of mixing, the rotor speed is reduced to 3 m/s, and 0.010 kg of dried silica press cake is added to the pan. After 1.5 more minutes of mixing, the rotor and pan are stopped, the pan is removed from the mixer, and the beads are poured out into a large pan. The beads are then dried with air between 120° C. and 160° C. to 7% moisture, and sieved to the desired particle size range. The beads have a bulk density of 0.44 g/cc.

### Example 2: Porous Silica Beads Using Sodium Silicate Binder

Silica press cake (0.755 Kg., 23.80% wt/wt water) is weighed into the pan of a Model RV02E Eirich Laboratory Mixer fitted with a pin type rotor tool. The pan is then mounted onto the mixer. The rotor is started at 15 m/s, and the pan is started at 37.5 RPM in a counter-rotational direction. After 1 minute of mixing 0.61040 kg water is poured into the pan. After another 2 minutes of mixing, 0.08255 kg diluted sodium silicate (25% wt/wt N® silicate in water) is sprayed into the pan over 10 to 90 seconds. After a total of 3.75 minutes of mixing, the rotor speed is increased to 30 m/s. After 14 minutes total of mixing, the rotor speed is reduced to 20 m/s. After 15 minutes total of mixing, the rotor speed is reduced to 3 m/s, and 0.020 kg of dried silica press cake is added to the pan. After 1 more minute of mixing, the rotor and pan are stopped, the pan is removed from the mixer, and the beads are poured out into a large pan. The beads are then dried to 7% moisture with air between room temperature and 160° C., and sieved to the desired particle size range. The beads have a bulk density of 0.42 g/cc.

### Example 3: Porous Silica Beads Using Sodium Silicate Binder and Glass Dust

The process set forth in Example 2 was repeated except, instead of silica press cake alone, a 3/1 mixture of silica press cake and glass dust (Potters C-dust, less than 212 microns) was used. The beads from this experiment have a bulk density of 0.59 g/cc, higher than those of Examples 1 and 2.

### Example 4: Dry Time of Silica Beads

The following experiment was conducted to determine the drying efficiency of porous silicon oxides. Twenty g of waterborne latex paint (Sherwin Williams yellow paint) was placed in a 4 oz. plastic cup with 10 g of a 2/1 mixture of type I AASHTO M247 glass beads and drying agent. The mixture was added to the paint and stirred by hand using a wood spatula (wood applicator). The time that elapsed from the beginning until the paint could not be stirred any more (completely solidified) was determined and is shown in Table 1.

TABLE 1

| | Time for the paint to | |
|---|---|---|
| Products | solidify completely | |
| Paint without any drying agent | >80 | min |
| Silica granules | 10-15 | sec |
| 2/1 mixture with glass beads | | |
| Silica beads Example 1 | 10-15 | sec |
| 2/1 mixture with glass beads | | |
| Silica beads Example 2 | 10-15 | sec |
| 2/1 mixture with glass beads | | |
| Silica beads Example 3 | 40-45 | sec |
| 2/1 mixture with glass beads | | |
| Silica beads Example 3 | 10-15 | sec |
| 1/1 mixture with glass beads | | |

The above results show the drying efficiency of porous silica beads are similar to that of porous silica granules. Mixing with glass dust does not affect the drying effect.

### Example 5: Flow Properties of Porous Silica Beads Vs. Granules

The following experiment measures the flow properties of different porous silica based materials. A glass funnel (80 mm diameter, 75 mm stem height, and 5 mm stem diameter) was placed vertically in a clamp. Porous silica (50 g) was poured into the funnel while holding the bottom of the stem closed. When the stem was opened the time for all silica to flow out into a beaker placed under the funnel was measured. The data presented in Table 2 shows that the porous beads flow much faster than the granules. This difference can be significant when large quantities are used while striping highway marking lanes.

TABLE 2

| | Time for silica drying agent to |
|---|---|
| Products | flow out of the funnel |
| Silica granules | 46 sec |
| Silica beads Example 1 | 22 sec |
| Silica beads Example 2 | 25 sec |
| Silica beads Example 3 | 20 sec |

Any documents referenced above are incorporated by reference herein. Their inclusion is not an admission that they are material or that they are otherwise prior art for any purpose.

Although the invention is illustrated and described herein with reference to specific embodiments, the invention is not intended to be limited to the details shown. Rather, various modifications may be made in the details within the scope and range of equivalents of the claims and without departing from the invention.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Use of the term “about” should be construed as providing support for embodiments directed to the exact listed amount. No language in the specification should be construed as indicating any non-claimed element as essential to the practice of the invention.

Although the present invention has been described with respect to its application in highway marking paint compositions, it is to be distinctly understood that the present invention can be used in connection with other waterborne paints.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A highway marking paint comprising:
a. waterborne latex paint; and
b. porous silica beads having a pore volume in the range of 0.3 cc/g to 3.0 cc/g, a particle size ranging from 10 US Mesh to 150 US Mesh, and a pore volume in the range of 200 m²/g to 500 m²/g, said beads comprising silica and a binder.

2. The highway marking paint of claim 1 wherein said binder is polyvinylpyrrolidone

3. The highway marking paint of claim 1 wherein said binder is sodium silicate.

4. The highway marking paint of claim 3 wherein said porous silica beads further comprise glass dust.

5. The highway marking paint of claim 1 wherein the porous silica has a pore volume in the range of 0.5 cc/g to 1.5 cc/g.

6. The highway marking paint of claim 1 wherein the porous silica has a surface area in the range of pore volume in the range of 250 m²/g to 450 m²/g.

7. The highway marking paint of claim 1 wherein the porous silica constitutes from 1% to 20% by weight of the paint.

8. The highway marking paint of claim 1 further comprising retroreflective glass beads.

9. A highway marking having a thickness of at least 40 mil comprising:
a. waterborne latex paint;
b. porous silica beads having a pore volume in the range of 0.3 cc/g to 3.0 cc/g, a particle size ranging from 10 US Mesh to 150 US Mesh, and a pore volume in the range of 200 m²/g to 500 m²/g, said beads comprising silica and a binder.

10. The highway marking paint of claim 9 wherein said binder is polyvinylpyrrolidone

11. The highway marking paint of claim 9 wherein said binder is sodium silicate.

12. The highway marking paint of claim 11 wherein said porous silica beads further comprise glass dust.

13. The highway marking of claim 9 further comprising retroreflective glass beads.

14. The highway marking of claim 9 having a thickness of at least 60 mil.

15. The highway marking of claim 15 having a thickness of at least 90 mil.

16. The highway marking of claim 16 having a thickness of at least 120 mil.

17. A method of applying a highway marking comprising the steps of:
a. dispensing a stream of a waterborne latex paint;
b. forming a paint composition by directing into said stream of a waterborne latex paint a stream of porous silica beads having a pore volume in the range of 0.3 cc/g to 3.0 cc/g, a particle size ranging from 10 US Mesh to 150 US Mesh, and a pore volume in the range of 200 m²/g to 500 m²/g, said beads comprising silica and a binder; and
c. applying said paint composition to a transportation corridor at a thickness of at least 40 mil.

18. The method of claim 17 wherein retroreflective glass beads are directed into said stream of a waterborne latex paint together with said porous silica beads.

19. The method claim 17 wherein said porous silica beads further comprise glass dust.
